(19) United States
(12) Patent Application Publication
(10) Pub. No.: US 2020/0398231 A1
(43) Pub. Date: Dec. 24, 2020

(54) MICROBUBBLE GENERATOR AND COOLING WATER CIRCULATION SYSTEM EQUIPPED WITH SAME

(71) Applicant: TOYOTA BOSHOKU KABUSHIKI KAISHA, Aichi (JP)

(72) Inventor: Masasuke NAGATA, Aichi (JP)

(73) Assignee: TOYOTA BOSHOKU KABUSHIKI KAISHA, Aichi (JP)

(21) Appl. No.: 16/317,976

(22) PCT Filed: Jul. 24, 2017
(86) PCT No.: PCT/JP2017/026723

§ 371 Date: Jan. 15, 2019

(30) Foreign Application Priority Data
Jul. 28, 2016 (JP) 2016-148948

(51) Int. Cl. B01F 3/04; C02F 3/20

(52) U.S. Cl. CPC B01F 3/04262; B01F 3/04248; B01F 2003/04361; B01F 2003/04858; C02F 3/202

(57) ABSTRACT

The present microbubble generator is a microbubble generator for generating microbubbles in a liquid, including a straight pipe made of porous ceramics, having one end connected to a compressor and the other end blocked, and the straight pipe having an average pore diameter of 1.5 μm or less.

### TECHNICAL FIELD

The present invention relates to a microbubble generator and a cooling water circulation system equipped with the same, and more particularly to a microbubble generator for generating microbubbles in liquid and a cooling water circulation system equipped with the same.

### BACKGROUND ART

While a swirl flow type, a venturi type, an ejector type, and a pressurized dissolution type are known as conventional microbubble generators, there are some problems: first, bubbles or droplets cannot be sufficiently reduced in size. Second, even though they can be sufficiently reduced in size, the amount generated is small. Third, the generators above each have a complicated structure that requires much time and labor to manufacture it, and that is very expensive.

Thus, various techniques have been proposed as a microbubble generator that solves the above problems (e.g., refer to Patent Literatures 1 and 2). Patent Literature 1 discloses an ultrafine bubble generator including a compressor for pumping a gas, and a bubble generating medium for discharging the pumped gas into a liquid as ultrafine bubbles, wherein the bubble generating medium is formed of a high-density composite, and there is provided a liquid injector for injecting the same kind of liquid as that of the liquid into which ultrafine bubbles are discharged, in a direction substantially orthogonal to a discharge direction of the ultrafine bubbles (refer to FIG. 1 of Patent Literature 1).

Patent Literature 1 also discloses that the bubble generating medium is formed in a hollow columnar shape, and the pumped gas passes through a gas supply path to be pumped to an internal space provided in a central portion of the bubble generating medium (refer FIG. 6(a) of Patent Literature 1). It is disclosed that the configuration described above causes gas to be uniformly discharged from a surface of the bubble generating medium, which is a side surface of the columnar shape, to enable ultrafine bubbles to be efficiently generated (refer to the paragraph [0036]).

In addition, Patent Literature 1 discloses that the bubble generating medium is formed in a conical shape, and the pumped gas passes through a gas supply path to be pumped to an internal space provided in a central portion of the bubble generating medium (refer FIG. 6(a) of Patent Literature 1). It is disclosed that the configuration described above causes gas to be uniformly discharged from a surface of the bubble generating medium, which is a side surface of the conical shape, to enable ultrafine bubbles to be efficiently generated (refer to the paragraph [0038]).

Meanwhile, Patent Literature 2 discloses an ultrafine bubble generator including a bubble generating medium that is formed of a high-density composite, and that is formed in a porous structure having many fine holes each with a diameter of several micrometers or less (refer to FIG. 6 of Patent Literature 2). In addition, it is disclosed that ultrafine bubbles separate from the bubble generating medium at the moment when being generated, to enable the bubbles to be prevented from coalescing into large bubbles, whereby a water flow generating device and the like do not need to be prepared to enable reduction in cost (refer to the paragraph [0056]).

### CITATIONS LIST

### Patent Literatures

Patent Literature 1: Japanese Unexamined Patent Application Publication No. 2010-167404

Patent Literature 2: Japanese Unexamined Patent Application Publication No. 2012-137265

### SUMMARY OF INVENTION

### Technical Problems

Unfortunately, the technique disclosed in Patent Literature 1 described above is configured such that a 0.3 μm equivalent mist filter is not provided between the compressor and the bubble generating medium. This causes air as the gas to be supplied while the air contains a minute amount of oil. In this case, when the air passes through pores of the bubble generating medium from the internal space thereof, its oil component adheres to the pores to cause clogging, thereby failing to generate ultrafine bubbles. In addition, as illustrated in FIG. 13(a), when a bubble generating medium 141 is formed in a columnar shape, for example, bubbles generated may be varied in size depending on a level of a difference between an outer diameter and an inner diameter of the bubble generating medium 141, and a level of gas pressure. Further, as illustrated in FIG. 13(b), when the bubble generating medium 141 is formed in a conical shape, for example, a distance of a path for causing pumped gas to enter the internal space of the bubble generating medium 141 and to pass through pores of the medium to reach a surface of the medium is relatively long on an inlet side of the medium, thereby generating ultrafine bubbles. As the distance decreases toward a back side of the internal space, the bubbles gradually increase in size. As a result, uniform bubbles cannot be discharged from the surface of the medium.

Gas cannot pass through pores of the high-density composite without an internal space, so that no ultrafine bubble is generated. While there are many kinds of raw material for a method for manufacturing porous ceramics, pores are formed in a vertically split structure. This causes bubbles to be released when gas passes through the pores, each having a complicated shape, only from a portion with an internal space and flows out from a surface of a bubble generating medium.

The technique disclosed in Patent Literature 2 is configured such that the bubble generating medium is disposed in a water tank along its vertical direction. This causes bubbles separated from the bubble generating medium to be more likely to coalesce into a large bubble when the bubbles rise in a pipe. In addition, the bubble generating medium 141 is formed in a conical shape as illustrated in FIG. 13(c), for example, so that uniform bubbles cannot be discharged from the surface of the medium.

Cooling tower circulating water and chiller circulating water used in factory facilities and the like cause the following problems due to deterioration in water quality of cooling water: adhesion, deposition, and clogging of a flow channel, of scales; corrosion, rust, and water leakage; and occurrence of slime and algae, in a mold cooling hole, a cooling pipe, a heat exchanger, and the like. As a result, the following various problems occurs: unstable quality of a molding (a mold cannot be maintained at a constant temperature, and a silver defect due to insufficient cooling is likely to occur): waste of electric power and energy (increase in power consumption due to deterioration in a heat exchange rate of a heat exchanger, increase in the amount of emission of CO2, and increase of trouble about abnormal high pressure of a heat exchanger); and increase in facility management cost (increase of electricity charges for facilities, increase of chemical cleaning cost, and increase of cleaning maintenance cost). Thus, there is desired the appearance of a cooling water circulation system capable of circulating cooling water improved in water quality. Particularly, a chiller circulating water (or a secondary cooling circulation (cold water or hot water region)) system under severe conditions requires accuracy of bubble size because a larger size of a generated bubble causes cavitation inside a cooling apparatus with a small-sized cooling pipe to reduce cooling efficiency.

The present invention is made in light of the above-described circumstances, and an object thereof is to provide a microbubble generator having a simple and inexpensive structure capable of uniformly generating ultrafine high concentration microbubbles in a liquid, and a cooling water circulation system equipped with the microbubble generator. SOLUTIONS TO PROBLEMS

In order to solve the above problem, the invention as defined in claim 1 relates to a microbubble generator for generating microbubbles in a liquid, comprising a straight pipe made of porous ceramics having one end connected to a compressor and the other end blocked, the straight pipe having an average pore diameter of 1.5 μm or less.

The invention as defined in claim 2 relates to the microbubble generator according to claim 1, wherein the straight pipe has an outer diameter and an inner diameter that are different by 8 mm to 17 mm.

The invention as defined in claim 3 relates to the microbubble generator according to claim 1 or 2, wherein a filter for removing an oil component in gas pumped by the compressor is provided in a pipe connecting one end of the straight pipe to the compressor.

The invention as defined in claim 4 relates to the microbubble generator according to any one of claims 1 to 3, further comprising a housing that is provided in its upper portion with an inflow port of a liquid and in its lower portion with an outflow port of a liquid, wherein the straight pipe is disposed in the housing such that its axis faces a horizontal direction.

The invention as defined in claim 5 relates to the microbubble generator according to claim 4, wherein the straight pipe is in a lower portion in the housing.

The invention as defined in claim 6 relates to the microbubble generator according to claim 4 or 5, wherein the outflow port is provided in a side wall of the housing, and the straight pipe is disposed in the housing so as to have a vertical distance of 200 mm or less between the axis of the straight pipe and an axis of the outflow port.

The invention as defined in claim 7 relates to the microbubble generator according to any one of claims 4 to 6, wherein the outflow port is provided in the side wall of the housing, and the straight pipe is disposed in the housing such that the axis of the straight pipe and the axis of the outflow port intersect with each other in plan view.

The invention as defined in claim 8 relates to the microbubble generator according to any one of claims 4 to 7, wherein the inflow port is provided in the side wall of the housing, and the outflow port is provided in the side wall of the housing on a side facing the inflow port.

The invention as defined in claim 9 relates to the microbubble generator according to any one of claims 4 to 8, wherein the housing is provided in its upper portion with a gas vent valve for venting gas stored in an upper portion of the housing.

In order to solve the above problem, the invention as defined in claim 10 relates to a cooling water circulation system for circulating cooling water in a circulation path, comprising the microbubble generator according to any one of claims 1 to 9.

### Advantageous Effects of Invention

The microbubble generator of the present invention includes a straight pipe made of porous ceramics having one end connected to the compressor and the other end blocked, and the straight pipe has an average pore diameter of 1.5 μm or less. As a result, gas pumped to the internal space of the straight pipe by the compressor passes through the pores of the straight pipe to become ultrafine high concentration microbubbles that are uniformly discharged into a liquid from the entire surface of the straight pipe. In addition, using a straight pipe made of porous ceramics enables a simple and inexpensive structure to be obtained.

When the straight pipe has an outer diameter and an inner diameter that are different by 8 mm to 17 mm, microbubbles are more uniformly generated in the liquid.

When a filter is provided in a pipe connecting the one end of the straight pipe and the compressor, the filter removes an oil component in the gas pumped by the compressor. This prevents the pores of the straight pipe from being clogged by the oil component.

When there is provided a housing that is provided in its upper portion with an inflow port of a liquid and in its lower portion with an outflow port of a liquid, and when the straight pipe is disposed in the housing such that its axis faces a horizontal direction, a liquid flowing through the housing can contain a large amount of microbubbles.

When the straight pipe is disposed in the lower portion of the housing, a liquid flowing in the housing can contain a larger amount of microbubbles.

When the outflow port is provided in a side wall of the housing, and the straight pipe is disposed in the housing so as to have a vertical distance of 200 mm or less between the axis of the straight pipe and the axis of the outflow port, a liquid flowing in the housing can contain a larger amount of microbubbles.

When the outflow port is provided in the side wall of the housing, and the straight pipe is disposed in the housing such that the axis of the straight pipe and the axis of the outflow port intersect with each other in plan view, a liquid flowing in the housing can contain a larger amount of microbubbles.

When the housing is provided in its upper portion with an air vent valve, gas accumulation in the housing is eliminated, and a liquid smoothly flows in the housing.

The cooling water circulation system of the present invention includes the microbubble generator described above. As a result, ultrafine high concentration microbubbles can be evenly generated in cooling water. When the cooling water improved in water quality (or cooling water containing microbubbles) is circulated in a circulation path, contamination and clogging of the circulation path can be prevented and water quality of the cooling water can be maintained, thereby enabling further improvement in cooling efficiency. For example, when cooling water improved in water quality is circulated in the circulation path, a cluster of water (H2O aggregate) is decomposed to become permeable and smooth water. Then, OH radicals are generated to decompose and clean a rust lump, a scale deposit, an organic matter, and the like. In addition, the oxidation-reduction potential is negatively charged to cause the water to become minus ion water (weak alkali). Then, odors of molds, algae, and the like are removed from the circulating cooling water. The microbubbles have heat conduction about 1.8 times that of water, so that the cooling efficiency of sprinkle water cooling of a cooling tower, a heat exchanger, a cooling apparatus, and the like is improved.

### BRIEF DESCRIPTION OF DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a general schematic view of a cooling water circulation system according to an example.

FIG. 2 is a plan view of a microbubble generator according to the example.

FIG. 3 is a side view of the microbubble generator, illustrating a part of it as a sectional view.

FIG. 4 is a view as viewed from arrow IV in FIG. 3.

FIG. 5 is an explanatory view for illustrating a housing of the microbubble generator.

FIG. 6 is an explanatory view for illustrating a gas vent valve of the microbubble generator, in which FIG. 6(a) illustrates an ascending state of a float and FIG. 6(b) illustrates a descending state of the float (a state of exhausting air).

FIG. 7 is an explanatory view for illustrating a microbubble generator according to another aspect, in which FIG. 7(a) illustrates a microbubble generator for a cooling tower, FIG. 7(b) illustrates a microbubble generator for a chiller machine, and FIG. 7(C) illustrates a microbubble generator with a single straight pipe.

FIG. 8 illustrates a differential pore volume distribution of each of straight pipes according to Experimental Examples 1 to 3 and Comparative Examples 1 and 2.

FIG. 9 is a table showing pore accuracy of each of the straight pipes according to Experimental Examples 1 to 3 and Comparative Examples 1 and 2.

FIG. 10 is an explanatory view for illustrating experiments for generating microbubbles using straight pipes according to Experimental Example 1, in which FIG. 10(a) illustrates a straight pipe having an outer diameter of 14 mm and an inner diameter of 8.8 mm, FIG. 10(b) illustrates a straight pipe having an outer diameter of 20 mm and an inner diameter of 16 mm, FIG. 10(c) illustrates a straight pipe having an outer diameter of 20 mm and an inner diameter of 14 mm, and FIG. 10(d) illustrates a straight pipe having an outer diameter of 20 mm and an inner diameter of 8.5 mm.

FIG. 11 shows results of a heat efficiency experiment of microbubbles using the straight tube illustrated in FIG. 10(d).

FIG. 12 is an explanatory view for illustrating a microbubble generator according to yet another aspect.

FIG. 13 is an explanatory view for illustrating a conventional bubble generating medium, in which FIG. 13(a) illustrates a bubble generating medium in a columnar shape, FIG. 13(b) illustrates a bubble generating medium in a conical shape, and FIG. 13(c) illustrates a bubble generating medium in a conical shape.

### DESCRIPTION OF EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

<Microbubble Generator>

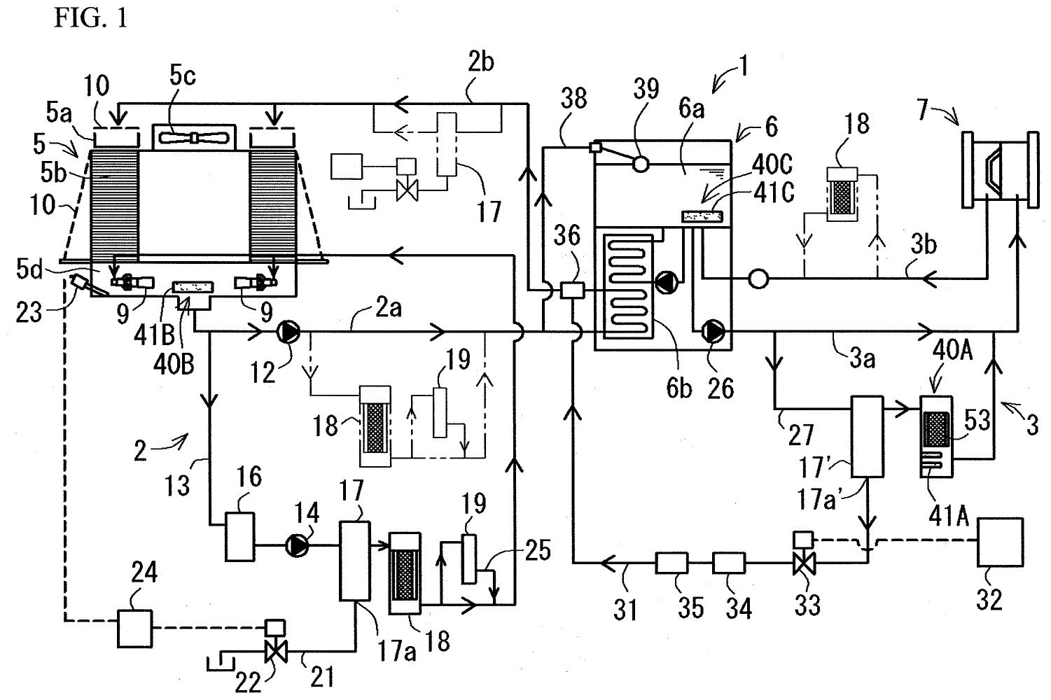

Microbubble generators according to the present embodiment are microbubble generators (40A, 40B, and 40C) for generating microbubbles in a liquid, including respectively straight pipes (41A, 41B, and 41C) made of porous ceramics, each of which has one end connected to a compressor (42) and the other end blocked, and each of the straight pipes having an average pore diameter of 1.5 μm or less (e.g., refer to FIG. 1).

The straight pipe described above means a pipe extending axially straight. The straight pipe is not particularly limited in size, ceramic material, the number thereof, and the like. The straight pipe has an average pore diameter of 0.1 μm to 1.5 μm, for example (preferably 0.4 μm to 1.4 μm, particularly 1.0 μm to 1.3 μm). The average pore diameter of the straight pipe is measured by a mercury intrusion method using a mercury porosimeter (manufactured by Shimadzu Corporation, trade name: Autopore IV 9500).

Gas is pumped to the straight pipe under a pressure of 0.05 MPa to 1.0 MPa, for example (preferably 0.1 MPa to 0.5 MPa, particularly 0.1 MPa to 0.3 MPa). Microbubbles discharged from a surface of the straight pipe have an amount of 30 L/min to 300 L/min, for example (preferably 50 L/min to 200 L/min, particularly 70 L/min to 150 L/min). The straight pipe is preferably made of porous alumina. This alumina is most used in a wide field, and is an oxide of aluminum represented by a composition formula Al2O3. The alumina is widely used as an industrial product, is relatively inexpensive, and has high heat resistance, high insulation, and the like, so that it is used for refractories of a high-temperature furnace, a protective tube of a thermocouple, or a substrate of electronic parts.

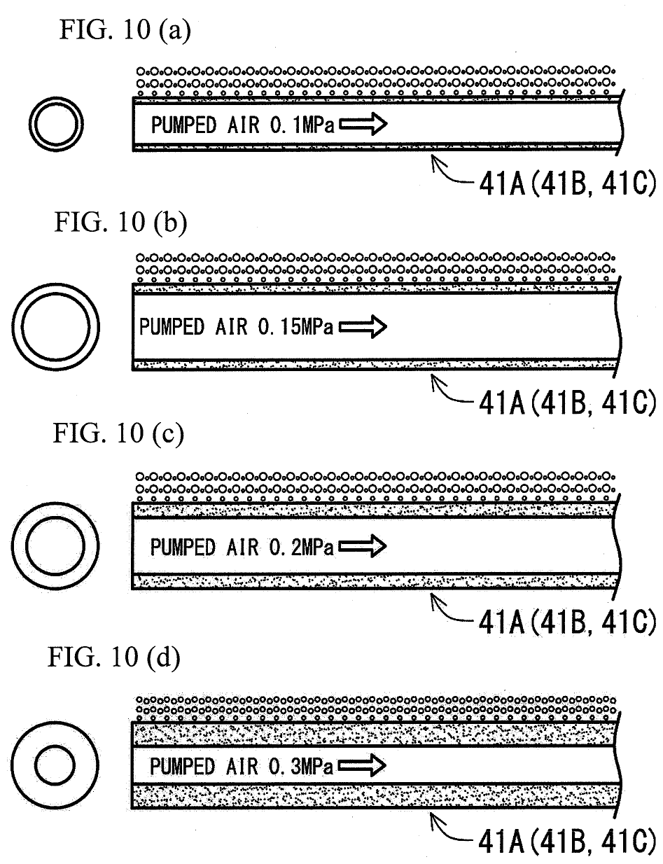

The microbubble generator according to the present embodiment may include an aspect in which the straight pipes (41A to 41C) each have an outer diameter and an inner diameter that are different by 8 mm to 17 mm (preferably 9 mm to 15 mm, particularly 10 mm to 13 mm), for example (e.g., refer to FIG. 10(d)).

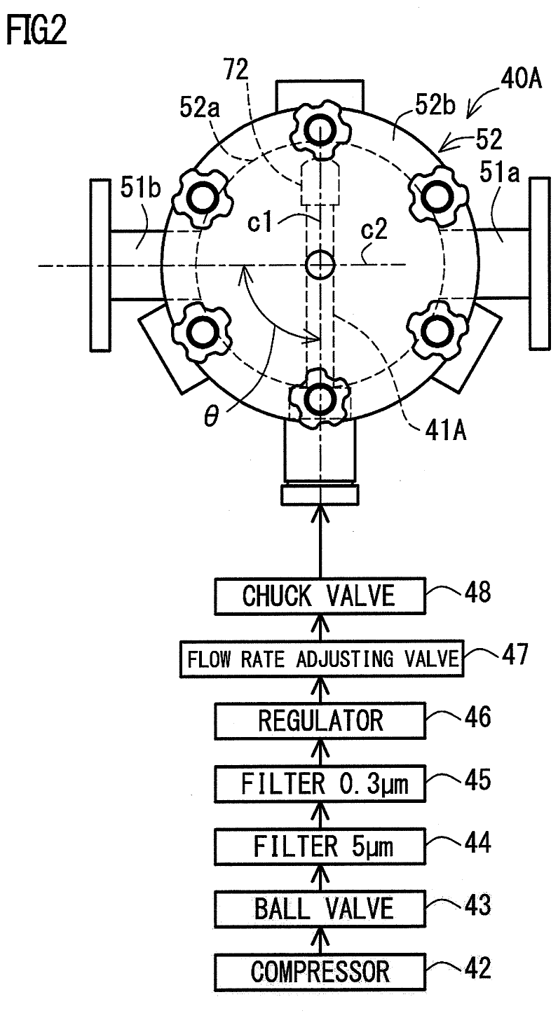

The microbubble generator according to the present embodiment may include an aspect in which a pipe connecting the one end of each of the straight pipes (41A to 41C) and the compressor (42) is provided with a filter (45) for removing an oil component in gas pumped by the compressor, for example (e.g., refer to FIG. 2, etc.). In this case, the pipe downstream of the filter (45) may be provided with a pressure adjustment regulator (46), a flow rate adjustment valve (47), and a chuck valve (48) for preventing a reverse flow of a liquid when pumping by the compressor is stopped, for example. This prevents deterioration in performance of high concentration microbubbles discharged from the straight pipe.

The microbubble generator according to the present embodiment may include an aspect in which there is provided a housing (52) that is provided in its upper portion with an inflow port (51a) of a liquid, and in its lower portion with an outflow port (51b) of a liquid, and the straight pipe (41A) is disposed in the housing such that its axis (c1) faces a horizontal direction, for example (e.g., refer to FIGS. 2 to 4, etc.). The housing is not particularly limited in size, shape, material, and the like.

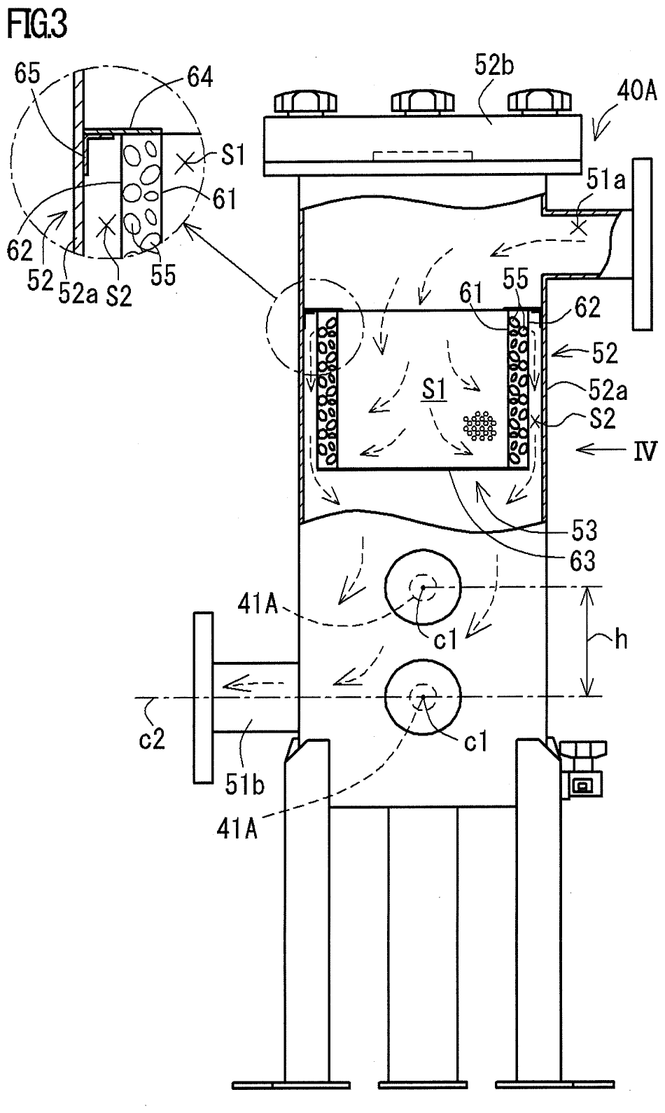

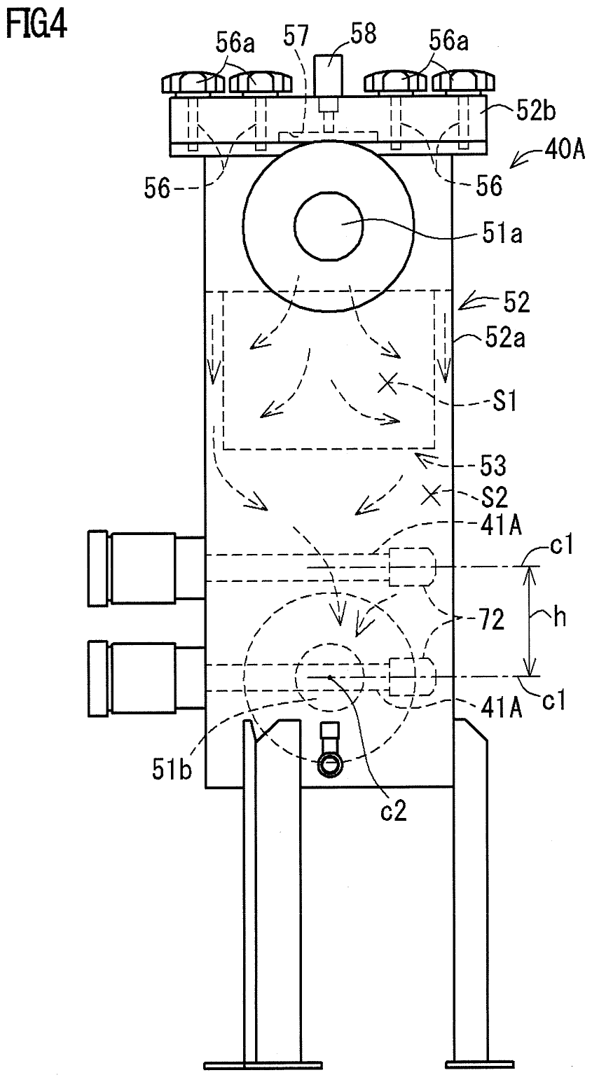

The aspect described above may be configured such that the straight pipe (41A) is disposed in a lower portion in the housing (52), for example (e.g., refer to FIGS. 3 and 4). The lower portion means a lower region when the internal space of the housing is vertically partitioned in half.

The aspect described above may be configured such that the outflow port (51b) is provided in a side wall of the housing (52), and such that the straight pipe (41A) is disposed in the housing so as to have a vertical distance (h) of 200 mm or less (preferably 150 mm or less, particularly 120 mm or less) between the axis (c1) of the straight pipe and an axis (c2) of the outflow port, for example (e.g., refer to FIGS. 3 and 4, etc.).

The aspect described above may be configured such that the outflow port (51b) is provided in the side wall of the housing (52), and such that the axis (c1) of each of the straight pipes (41A to 41C) and the axis (c2) of the outflow port (51b) intersect with each other, for example (e.g., refer to FIG. 2, etc.). In this case, an intersecting angle (θ) between the axis of the straight pipe and the axis of the outflow port may be 30 degrees to 150 degrees (preferably 60 degrees to 120 degrees, particularly 80 degrees to 100 degrees), for example.

The aspect described above may be configured such that the inflow port (51a) is provided in the side wall of the housing (52), and such that the outflow port (51b) is provided in the side wall of the housing (52) on a side facing the inflow port, for example (e.g., refer to FIG. 3, etc.).

The aspect described above may be configured such that the housing (52) is provided in its upper portion with a gas vent valve (58) for venting gas stored in the upper portion of the housing, for example (e.g., refer to FIG. 4, etc.).

The aspect described above may be configured such that the housing (52) is provided in its inside with a container (53 or 79) for containing a water treatment agent (80) composed of a tourmaline granules (55) and/or an inorganic substance, and such that the straight pipe (41A) is disposed below the container (53 or 79), for example (e.g., refer to FIGS. 3 and 12, etc.). This enables a liquid flowing in the housing to be effectively improved in quality.

<Cooling Water Circulation System>

A cooling water circulation system according to the present embodiment is a cooling water circulation system (1) that circulates cooling water in each of circulation paths (2 and 3), and includes the microbubble generators (40A to 40C) according to the above embodiment (e.g., refer to FIG. 1).

The microbubble generator may be formed by combining one or more kinds of microbubble generator that are as follows: the microbubble generator (40A) including the straight pipe (41A) disposed in the housing (52) provided in a chiller-machine-side circulation path (3) for circulating cooling water between a chiller machine (6) and a cooling target part (7); a microbubble generator including a straight pipe disposed in a housing provided in a cooling-tower-side circulation path (2) for circulating cooling water between a cooling tower (5) and the chiller machine (6); the microbubble generator (40B) including the straight pipe (41B) disposed in a water tank (5d) of the cooling tower (5); and the microbubble generator (40C) including a straight pipe (41C) disposed in a tank (6a) of the chiller machine (6).

The reference numeral in parentheses of each component described in the above embodiment indicates a correspondence with a specific component described in an example to be described below.

### EXAMPLE

Hereinafter, the present invention will be described in detail using an example with reference to the drawings.

(1) Configuration of Cooling Water Circulation System

As illustrated in FIG. 1, a cooling water circulation system 1 according to the present example circulates cooling water in a circulation path, and includes microbubble generators 40A, 40B, and 40C described below. The circulation path includes a cooling-tower-side circulation path 2 for circulating the cooling water between a cooling tower 5 and a chiller machine 6, and a chiller-machine-side circulation path 3 for circulating the cooling water between a chiller machine 6 and a cooling target part 7. Examples of the cooling target part 7 include an injection molding device, a press working device, a welding device, a heating device, a trimming device, and the like.

The cooling tower 5 includes a water sprinkling tank 5a for storing and sprinkling cooling water increased in temperature fed from the chiller machine 6, a filling material 5b for cooling the water sprinkled from the water sprinkling tank 5a with air, a blower 5c for taking in outside air through a suction port to allow the outside air to pass through the inside of the filling material 5b, and a water tank 5d for storing the cooling water dropped while being cooled by the filling material 5b. The water tank 5d is provided in its inside with the straight pipe 41B of the microbubble generator 40B described below, and an injector 9 for removing precipitate such as slime precipitating on the bottom of the water tank 5d. In addition, a multifunctional net 10 is stretched so as to cover the suction port and the water sprinkling tank 5a of the cooling tower 5. The multifunction net 10 not only prevents algae, slime, legionella bacteria, and the like from occurring in the cooling tower but also improves cooling efficiency therein.

The chiller machine 6 includes a tank 6a for storing cooling water increased in temperature fed from the cooling target part 7, and a heat exchanger 6b for cooling the cooling water in the tank 6a. The tank 6a is provided in its inside with the straight pipe 41C of the microbubble generator 40C described below.

The cooling-tower-side circulation path 2 includes a feed path 2a that is connected at one end to the water tank 5d of the cooling tower 5 and at the other end to the heat exchanger 6b of the chiller machine 6, and a return path 2b that has one end connected to the heat exchanger 6b of the chiller machine 6 and the other end connected to the water sprinkling tank 5a of the cooling tower 5. The feed path 2a is provided with a pressure pump 12 for pumping the cooling water in the water tank 5d of the cooling tower 5 toward the heat exchanger 6b of the chiller machine 6. In addition, an introduction pipe 13 has one end connected to the injector 9 and the other end connected to the feed path 2a upstream of the pressure pump 12. The introduction pipe 13 is provided with a pressure feed pump 14 for pumping the cooling water in the water tank 5d of the cooling tower 5 toward the injector 9. Then, the injector 9 injects the cooling water pumped by the pressure pump 14 to remove precipitate precipitating on the bottom of the water tank 5d.

The introduction pipe 13 includes a basket filter 16 containing a water treatment agent made of an inorganic substance or the like, a water impurity separation device 17 for removing impurities contained in the cooling water, and a tourmaline treatment device 18 for treating the cooling water with tourmaline granules. The water impurity separation device 17 has a drain port 17a connected to a drain pipe 21 that is opened and closed by an on-off valve 22. The on-off valve 22 is controlled to be opened and closed by a control unit 24 in accordance with a detection value from a sensor 23 for detecting electric conductivity of cooling water. When the drain pipe 21 is opened, the cooling water is discharged together with impurities from the drain port 17a of the impurity separation device 17. The introduction pipe 13 is provided with a bypass path 25, and the bypass path 25 is provided with a magnetic water treatment device 19 for magnetically treating cooling water.

While the water impurity separation device 17 provided in the introduction pipe 13 is shown in the present example, the present invention is not limited to this. For example, the water impurity separation device 17 may be provided in the return path 2b (or the feed path 2a) of the cooling tower circulation path 2 instead of or in addition to the introduction pipe 13, as illustrated in FIG. 1 by an imaginary line.

While the tourmaline treatment device 18 provided in the introduction pipe 13 is shown in the present example, the present invention is not limited to this. For example, the tourmaline treatment device 18 may be provided in the feed path 2a (or the return path 2b) of the cooling-tower-side circulation path 2 instead of or in addition to the introduction pipe 13, as illustrated in FIG. 1 by an imaginary line. In addition, the tourmaline treatment device 18 may be provided in the return path 3b (or the feed path 3a) of the chiller-machine-side circulation path 3.

The chiller-machine-side circulation path 3 includes a feed path 3a that has one end connected to the tank 6a of the chiller machine 6 and the other end connected to the cooling target part 7, and a return path 3b that has one end connected to the cooling target part 7 and the other end connected to the tank 6a of the chiller machine 6. The feed path 3a is provided with a pressure pump 26 for pumping cooling water in the tank 6a of the chiller machine 6 toward the cooling target part 7. In addition, a bypass path 27 is provided downstream of the pressure pump 26 in the feed path 3a. The bypass path 27 includes a water impurity separation device 17′ for removing impurities contained in cooling water, and the microbubble generator 40A described below.

The cooling-tower-side circulation path 2 and the chiller-machine-side circulation path 3 are connected by a first connection pipe 31 for introducing cooling water circulating in the chiller-machine-side circulation path 3 into the cooling-tower-side circulation path 2. The first connection pipe 31 connects the return path 2b of the cooling-tower-side circulation path 2 to a drain port 17a′ of the water impurity separation device 17′. The first connection pipe 31 is provided with an electric valve 33 of a ball valve type for opening and closing the first connection pipe 31 by opening and closing control of a control unit 32, a constant flow valve 34 of a washer rubber type, and a check valve 35 for preventing a reverse flow of cooling water. The electric valve 33 is controlled to be opened and closed with a timer function of the control unit 32. The first connection pipe 31 is provided at its one end with a differential pressure injector 36 disposed in a pipe constituting the cooling-tower-side circulation path 2.

The cooling-tower-side circulation path 2 and the chiller-machine-side circulation path 3 are connected by a second connection pipe 38 for introducing the cooling water circulating in the cooling-tower-side circulation path 2 to the chiller-machine-side circulation path 3. The second connection pipe 38 connects the feed path 2a of the cooling-tower-side circulation path 2 and the tank 6a of the chiller machine 6. The second connection pipe 38 is provided at its one end with a float valve 39 for opening and closing the second connection pipe in accordance with vertical movement of the water surface in the tank 6a.

(2) Configuration of Microbubble Generator

As illustrated in FIGS. 2 to 4, the microbubble generator 40A according to the present example generates microbubbles in cooling water circulating through the chiller-machine-side circulation path 3, and includes a plurality of straight pipes 41A (two in the drawings) each made of porous ceramics in a cylindrical shape (or a hollow columnar shape), having one end connected to the compressor 42 and the other end blocked. The microbubble generator 40A includes a housing 52 in a cylindrical shape that is provided in its upper portion with an inflow port 51a for cooling water and in its lower portion with an outflow port 51b for cooling water. The inflow port 51a is provided in a side wall of the housing 52, and the outflow port 51b is provided in the side wall of the housing 52 on a side facing the inflow port. The microbubble generator 40A has not only a function of generating microbubbles in cooling water but also a function of bringing the cooling water into contact with tourmaline granules 55 to form tourmaline-treated water.

The present example is configured such that a straight pipe (refer to FIG. 10(d)) that is made of porous alumina having an average pore diameter of 1.2 μm, and that has an outer diameter of 20 mm and an inner diameter of 8.5 mm, is used as the straight pipe 41A. In addition, an air pressure of 0.15 MP is selected for pumping to the straight pipe 41A.

As illustrated in FIG. 2, a filter 45 (with a filtration accuracy of 0.3 μm) for removing an oil component in gas pumped by the compressor 42 is provided in a pipe connecting one end of the straight pipe 41A to the compressor 42. The pipe upstream of the filter 45 is provided with a ball valve 44 and a filter 43 (with a filtration accuracy of 5 μm). In addition, the pipe downstream of the filter 45 is provided with a pressure adjusting regulator 46, a flow rate adjusting valve 47, and a chuck bubble 48 for preventing a reverse flow of cooling water when pumping by the compressor 42 is stopped. The straight pipe 41A has a leading end that is closed by connecting a cap 72 thereto.

As illustrated in FIGS. 2 to 4, each of the straight pipes 41A is disposed in the lower portion of the housing 52 such that its axis c1 faces the horizontal direction while being juxtaposed vertically. Specifically, the upper straight pipe 41A is disposed so as to have a vertical distance h of 100 mm between the axis c1 of the upper straight pipe 41A and the axis c2 of the outflow port 51b. The lower straight pipe 41A is disposed such that its axis c1 aligns with the axis c2 of the outflow port 51b. In addition, each of the straight pipes 41A is disposed such that the axis c1 of each of the straight pipes 41A and the axis c2 of the outflow port 51b intersect each other at a predetermined intersection angle θ (e.g., 90 degrees) in plan view (refer to FIG. 2).

As illustrated in FIG. 3, the housing 52 is provided in its inside with a container 53 that is disposed so as to partition the internal space into an upstream space 51 and a downstream space S2 while containing the tourmaline granules 55. Each of the straight pipes 41A is disposed below the container 52.

The container 53 is formed in a double-cylinder shape. Specifically, the container 53 includes an upstream partition wall 61 in a cylindrical shape facing the upstream space S1, and a downstream partition wall 62 in a cylindrical shape facing the downstream space S2. The upstream partition wall 61 is provided with a plurality of inflow holes for allowing cooling water to flow into the container 53 from the upstream space S1. The downstream partition wall 62 is provided with a plurality of outflow holes for allowing the cooling water to flow out from the inside of the container 53 to the downstream space S2.

The container 53 includes a bottom wall 63 that blocks between lower ends of the respective upstream and downstream partition walls 61 and 62, and an upper wall 64 that blocks between the lower ends of the respective upstream and downstream partition walls 61 and 62. The bottom wall 63 is provided so as to close an inner peripheral side of the lower end of the upstream partition wall 61. The upper wall 64 is provided so as to open the inner peripheral side of the upper end of the upstream partition wall 61. In addition, the upper wall 64 extends to an outer peripheral side of the downstream partition wall 62 so as to be brought into contact with the side wall of the housing 52. The bottom wall 63 and the upper wall 64 are fixed to the partition walls 61 and 62 by caulking or the like.

The upper wall 64 is placed on a bracket 65 provided on the side wall of the housing 52. As a result, the container 53 is positioned in the housing 52, and can be put in and out the inside of a housing body 52a when a lid 52b is removed. The container 53 may contain a water treatment agent made of an inorganic material or the like on the inner peripheral side of the upstream partition wall 61.

As illustrated in FIGS. 4 and 5, the housing 52 is provided in its upper end portion with an air reservoir 57 for storing air, and a gas vent valve 58 for venting air stored in the air reservoir 57. The housing 52 includes the housing body 52a in a bottomed cylindrical shape having an opening at one end side in its axial direction (or at its upper end), and the lid 52b detachably attached to the housing body 52a so as to close the opening of the housing body 52a. The lid 52b is provided with the gas vent valve 58. The lid 52b is detachable from the housing body 52a when a screw 56 is screwed into and released from the housing body 52a by being rotated while an operation part 56a is gripped.

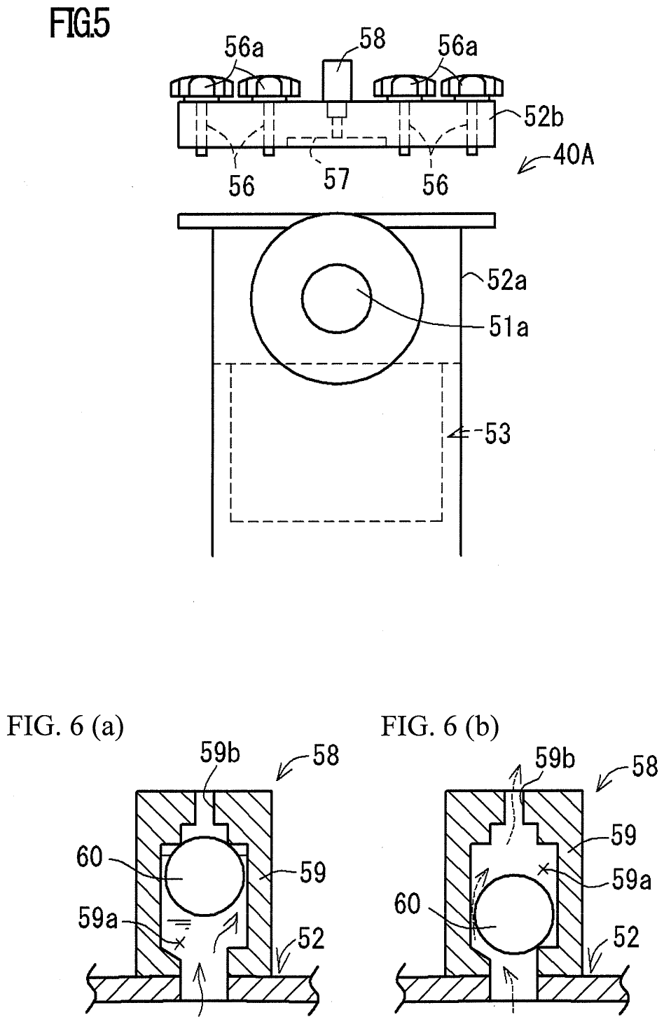

As illustrated in FIG. 6, the gas vent valve 58 includes a casing 59 provided with a valve chamber 59a and a gas vent hole 59b communicating with the valve chamber 59a, and a float 60 that is housed in the valve chamber 59a and moves up and down in accordance with vertical movement of the water surface of cooling water flowing into the valve chamber 59a. The gas vent valve 58 regulates outflow of water to the outside in a manner such that the float 60 is raised by the cooling water flowing into the valve chamber 59a from the housing 52 and is seated on a valve seat to close the gas vent hole 59b (refer to FIG. 6(a)). Meanwhile, when an inflow of the cooling water into the valve chamber 59a decreases, the float 60 descends and moves away from the valve seat, thereby opening the gas vent hole 59b to release air generated in the housing 52 into the atmosphere (refer to FIG. 6(b)).

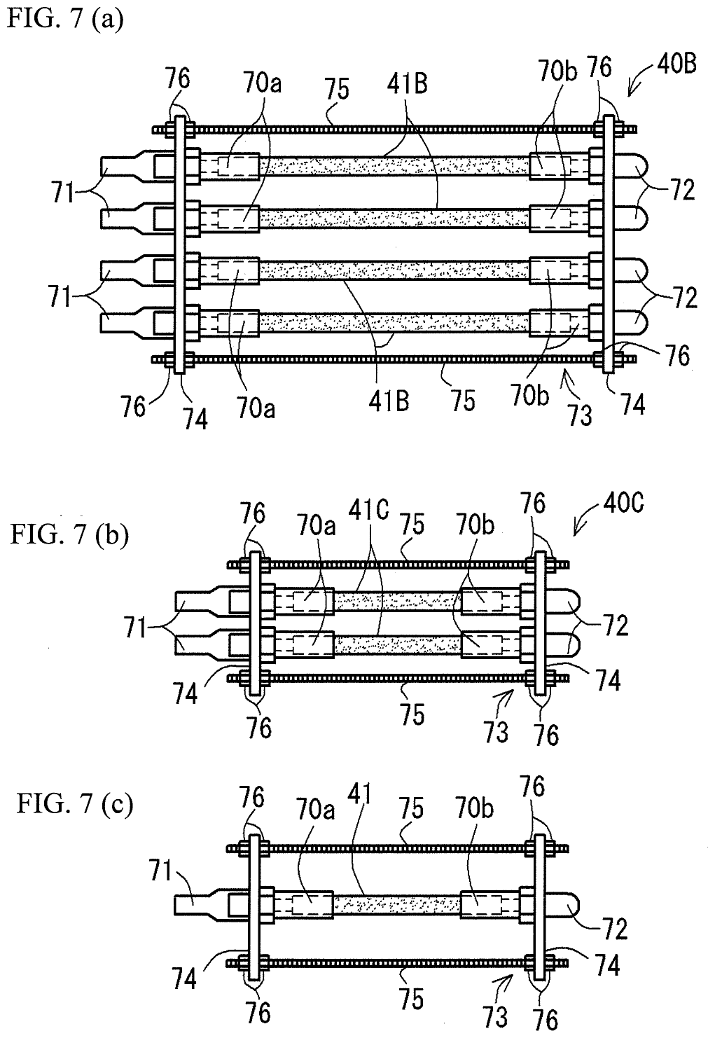

The microbubble generator 40B according to the present example generates microbubbles in the cooling water stored in the water tank 5d of the cooling tower 5 (refer to FIG. 1). As illustrated in FIG. 7(a), the microbubble generator 40B includes a plurality of straight pipes 41B (four in the drawings) each made of porous ceramics in a cylindrical shape (or a hollow columnar shape), having one end connected to the compressor 42 and the other end blocked. Each of the straight pipes 41B is disposed in a lower portion of the water tank 5d of the cooling tower 5 such that its axis faces the horizontal direction while being juxtaposed vertically.

The present example is configured such that a straight pipe (refer to FIG. 10(d)) that is made of porous alumina having an average pore diameter of 1.2 μm, and that has an outer diameter of 20 mm, an inner diameter of 8.5 mm, and an axial length of 500 mm, is used as the straight pipe 41B. In addition, an air pressure of 0.15 MP is selected for pumping to the straight pipe 41B.

The straight pipe 41B is connected at its axial ends to respective valve sockets 70a and 70b. To maintain airtightness between each of the sockets 70a and 70b, and the straight pipe 41B, two-component epoxy resin is injected into a gap therebetween. The socket 70a is connected to a reducing socket 71 made of stainless steel, and the socket 70b is connected to the cap 72 made of stainless steel. The cap 72 blocks the other end of the straight pipe 41B to form a structure in which pumped air does not leak.

The straight pipe 41B is supported by a support 73 that is provided with a pair of steel plates (brackets) 74 made of stainless steel, facing each other. Each of the steel plates 74 is provided with holes corresponding to the plurality of straight pipes 41B, and the socket 71 and the cap 72 are inserted in the corresponding holes. In addition, each of the steel plates 74 is provided in its four corners with respective holes into each of which a bolt 75 made of stainless steel is inserted and fixed with a nut 76. Thus, the plurality of straight pipes 41B is stably fixed in multiple rows between the pair of steel plates 74.

The straight pipe 41B is connected at one end (the socket 71) to the compressor 42 with a pipe that is provided with the ball bubble 43, the filter 44 (with a filtration accuracy of 5 μm), the filter 45 (with a filtration accuracy of 0.3 μm), the pressure adjusting regulator 46, the flow rate adjusting valve 47, and the chuck valve 48 in the order above described (refer to FIG. 2), substantially similarly to the straight pipe 41A described above.

The microbubble generator 40C according to the present example generates microbubbles in the cooling water stored in the tank 6a of the chiller machine 6 (refer to FIG. 1). As illustrated in FIG. 7(b), the microbubble generator 40C includes a plurality of straight pipes 41C (two in the drawings) each made of porous ceramics in a cylindrical shape (or a hollow columnar shape), having one end connected to the compressor 42 and the other end blocked. Each of the straight pipes 41C is disposed in a lower portion of the tank 6a of the chiller machine 6 such that its axis faces the horizontal direction while being juxtaposed vertically.

The present example is configured such that a straight pipe (refer to FIG. 10(d)) that is made of porous alumina having an average pore diameter of 1.2 μm, and that has an outer diameter of 20 mm, an inner diameter of 8.5 mm, and an axial length of 250 mm, is used as the straight pipe 41C. In addition, an air pressure of 0.15 MP is selected for pumping to the straight pipe 41C. The straight pipe 41C has a supporting structure and the like that are substantially identical to those of the straight pipe 41B, so that the same reference numerals are used and the detailed description is omitted.

(3) Action of Cooling Water Circulation System

Next, action of the cooling water circulation system 1 having the above configuration will be described. As illustrated in FIG. 1, cooling water circulating in the cooling-tower-side circulation path 2 is improved in water quality not only when flowing through the introduction pipe 13 by action of the basket filter 16, the water impurity separation device 17, the tourmaline treatment device 18, and the magnetic water treatment device 19, but also when being stored in the water tank 5d of the cooling tower 5 by action of the microbubble generator 40B. This causes the cooling water to not only be excellent in rust prevention and scaling resistance, but also have a cleaning function. Meanwhile, cooling water circulating in the chiller-machine-side circulation path 3 is improved in water quality not only by action of the water impurity separation device 17′ and the microbubble generator 40A with a tourmaline treatment function, but also by action of the microbubble generator 40C when being stored in the tank 6a of the chiller machine 6. This causes the cooling water to not only be excellent in rust prevention and scaling resistance, but also have a cleaning function.

Then, circulating the cooling water improved in water quality through the respective circulation paths 2 and 3 suppresses the following problems due to deterioration in water quality of cooling water: adhesion, deposition, and clogging of a flow channel, of scales; corrosion, rust, and water leakage; and occurrence of slime and algae, in a mold cooling hole, a cooling pipe, a heat exchanger, and the like. As a result, the following various merits can be obtained: stable quality of a molding (a mold can be maintained at a constant temperature, and a silver defect due to insufficient cooling is less likely to occur); power saving and energy saving (large reduction in power consumption by increase in a heat exchange rate of a heat exchanger, reduction in the amount of emission of CO₂ through power saving and water saving, and reduction of trouble about abnormal high pressure of a heat exchanger); and large reduction in facility management cost (reduction of electricity charges for facilities, reduction of chemical cleaning cost, and reduction of cleaning maintenance cost).

In addition, the cooling water circulation system 1 is configured such that when the electromagnetic valve 33 is opened by timer control of the control unit 32, cooling water together with impurities is introduced into the return path 2b of the cooling-tower-side circulation path 2 from the drain port 17a′ of the water impurity separation device 17′ via the first connection pipe 31. At this time, the differential pressure injector 36 injects cooling water (with a water pressure of 0.3 MPa, and at a flow rate of 1.8 L/min) flowing through the first connection pipe 31, lower in pressure than the cooling water (with a water pressure of 0.4 MPa, and at a flow rate of 120 L/min) flowing through a pipe constituting the cooling-tower-side circulation path 2, into the cooling water flowing through the pipe. Meanwhile, when the float valve 39 is operated in accordance with descent of the water surface of the tank 6a of the chiller machine 6, the cooling water flowing through the feed path 2a of the cooling-tower-side circulation path 2 is introduced to the tank 6a via the second connection pipe 38. That is, the cooling water contaminated in the chiller-machine-side circulation path 3 and the cooling water improved in water quality in the cooling-tower-side circulation path 2 are exchanged with each other.

The amount of water discharged from the water impurity separation device 17 is set within a range of 3% to 5% of the amount of circulating water in the chiller-machine-side circulation path 3 so as not to affect cooling efficiency of the chiller machine 6 in the chiller-machine-side circulation path 3, and the water is introduced into the return path 2b of the cooling-tower-side circulation path 2 from the constant flow valve 34 through the check valve 35. In addition, when the cooling-tower-side circulation path 2 has circulatory pressure lower than circulatory pressure of the chiller-machine-side circulation path 3, water can be discharged into the return path 2b of the cooling-tower-side circulation path 2 without providing the differential pressure injector 36.

The microbubble generators 40A to 40C according to the present example are configured such that air pumped into their internal spaces from one ends of the respective straight pipes 41A to 41C by the compressor 42 passes through pores of the respective straight pipes 41A to 41C to form ultrafine (with a bubble size of 6 μm to 12 μm) high concentration microbubbles (with a gas amount of 10 L/min) that are released into the cooling water from their entire outer peripheral surfaces.

Specifically, as illustrated in FIG. 3, the microbubble generator 40A is configured such that cooling water flowing into the upstream space S1 in the housing 52 from the inflow port 51a flows into the container 53 through the inflow holes of the upstream partition wall 61, and passes through the inside of the container 53, or among the tourmaline granules 55, toward a centrifugal side. Then, the cooling water is brought into contact with the tourmaline granules 55 with a strong pressure and impact, so that the piezoelectric effect that is the characteristic of the tourmaline appears to efficiently produce useful tourmaline-treated water. The cooling water (tourmaline-treated water) having passed through the container 53 flows out from the outflow holes of the downstream partition wall 62 into the downstream space S2 in the housing 52, and hits the side wall of the housing 52 to flow downward in the downstream space S2, thereby flowing into the lower portion of the housing 52. At this time, the cooling water contains a large amount of microbubbles generated from each straight pipe 41A, and flows out from the outflow port 51b in this state to circulate through the chiller-machine-side circulation path 3.

The microbubble generator 40B is configured such that cooling water stored in the water tank 5d of the cooling tower 5 contains a large amount of microbubbles generated from the straight pipe 41B, and flows out from the water tank 5d in this state to circulate through the cooling-tower-side circulation path 2. Further, the microbubble generator 40C is configured such that cooling water stored in the water tank 6a of the chiller machine 6 contains a large amount of microbubbles generated from the straight pipe 41C, and flows out from the tank 6b in this state to circulate through the chiller-machine-side circulation path 3.

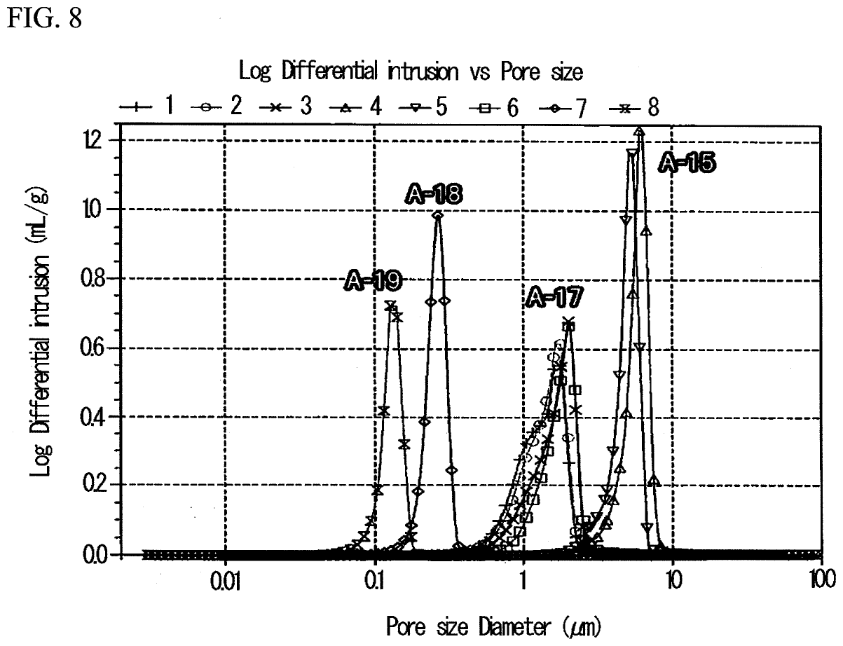

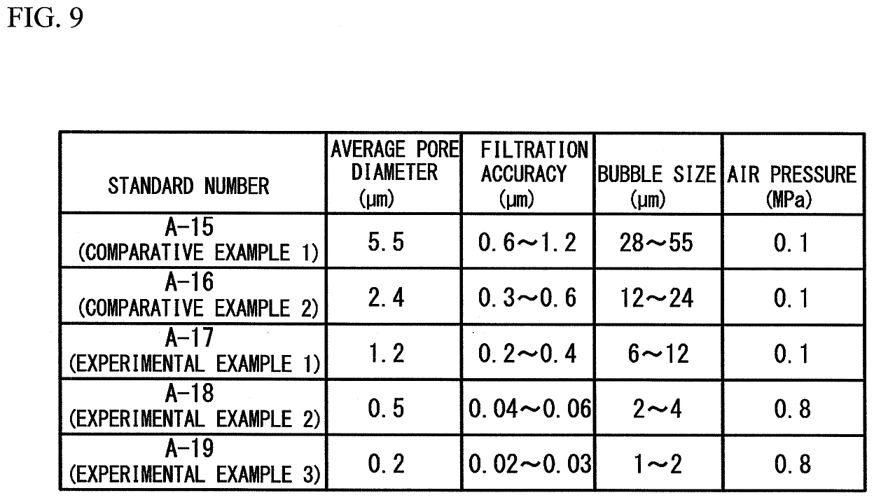

As illustrated in FIGS. 8 and 9, straight pipes of Experimental Examples 1 to 3 and Comparative Examples 1 and 2 will be described. Experimental Example 1 used a straight pipe (standard number of A-17) made of porous alumina having an average pore diameter of 1.2 μm. When the straight pipe was disposed in an experimental water tank as a single pipe and air under a pressure of 0.1 MPa was pumped to the straight pipe, microbubbles with a bubble size of 6 μm to 12 μm were generated in the experimental water tank. Experimental Example 2 used a straight pipe (standard number of A-18) made of porous zirconia having an average pore diameter of 0.5 μm. When the straight pipe was disposed in the experimental water tank as a single pipe and air under a pressure of 0.8 MPa was pumped to the straight pipe, microbubbles with a bubble size of 2 μm to 4 μm were generated. Experimental Example 3 used a straight pipe (standard number of A-19) made of porous zirconia having an average pore diameter of 0.2 μm. When the straight pipes 41A to 41C were each disposed in the experimental water tank as a single pipe and air under a pressure of 0.8 MPa was pumped to each of the straight pipes, microbubbles with a bubble size of 1 μm to 2 μm were generated.

Meanwhile, Comparative Example 1 used a straight pipe (standard number of A-15) made of porous alumina having an average pore diameter of 5.5 μm. When the straight pipe was disposed in the experimental water tank as a single pipe and air under a pressure of 0.1 MPa was pumped to the straight pipe, microbubbles with a bubble size of 28 μm to 55 μm were generated. Comparative Example 2 used a straight pipe (standard number of A-16) made of porous alumina having an average pore diameter of 2.4 μm. When the straight pipe was disposed in an incident water tank as a single pipe and air under a pressure of 0.1 MPa was pumped to the straight pipe, microbubbles with a bubble size of 12 μm to 24 μm were generated.

In a microbubble generation experiment using the straight pipe (standard number of A-17) according to Experimental Example 1, when the straight pipe (refer to FIG. 10(a)) having an outer diameter of 11.4 mm and an inner diameter of 8.8 mm was disposed in the experimental water tank as a single pipe and air under a pressure of 0.1 MPa was pumped to the straight pipe, microbubbles slightly varied in size. When a straight pipe (refer to FIG. 10(b)) having an outer diameter of 20 mm and an inner diameter of 16 mm was disposed as a single pipe in the experimental water tank and air under a pressure of 0.15 MPa was pumped to the straight pipe, microbubbles slightly varied in size. When a straight pipe (refer to FIG. 10(c)) having an outer diameter of 20 mm and an inner diameter of 14 mm was disposed as a single pipe in the experimental water tank and air under a pressure of 0.2 MPa was pumped to the straight pipe, microbubbles slightly varied in size. In contrast, when a straight pipe (refer to FIG. 10(d)) having an outer diameter of 20 mm and an inner diameter of 8.5 mm was disposed as a single pipe in the experimental water tank and air under a pressure of 0.3 MPa was pumped to the straight pipe, microbubbles hardly varied in size.

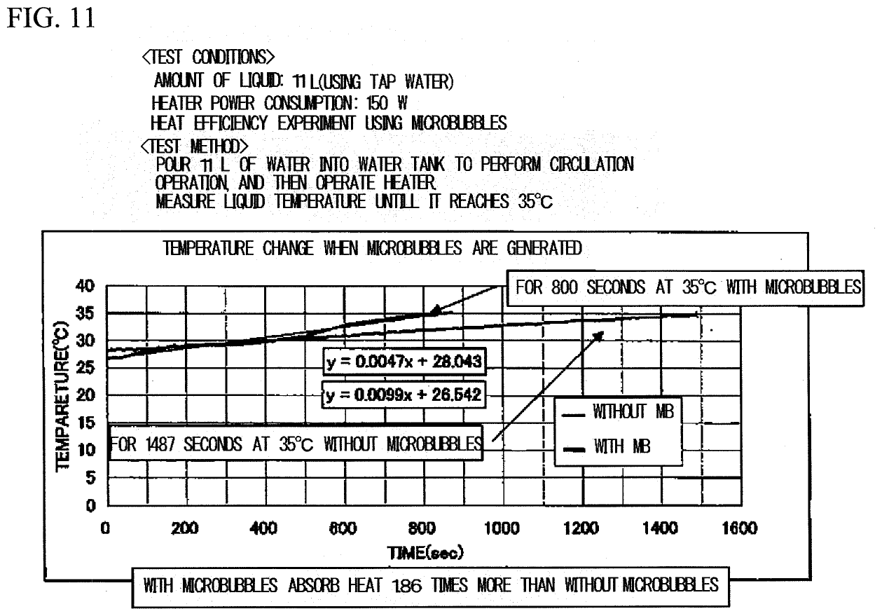

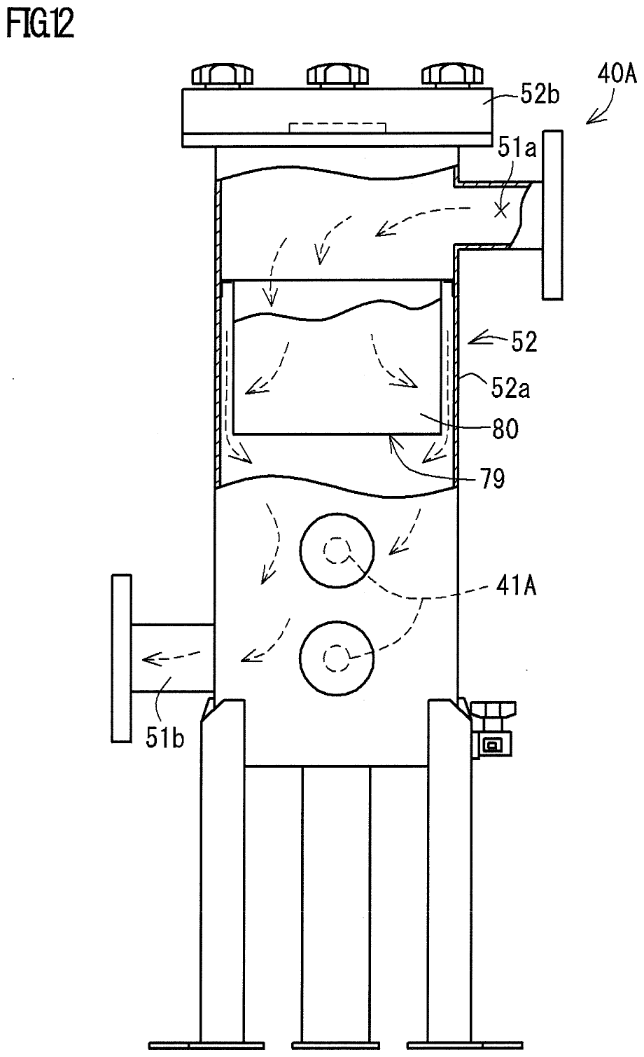

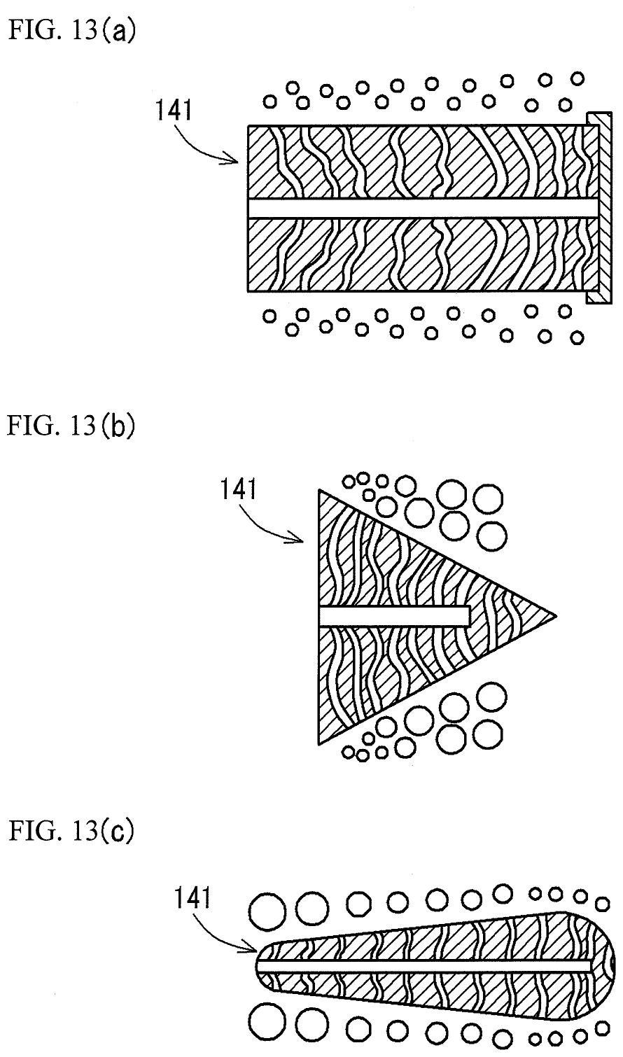

In addition, an experiment on efficiency of heat with and without microbubbles generated was performed. After circulation operation of a microbubble generator (using a straight pipe of a standard number of A-17) was performed in the experimental water tank into which 11 liters of water were poured, a 100 V voltage and 150 W power heater was immersed in the water tank, and then liquid temperature in the water tank was measured until the liquid temperature reached 35° C. As a result, it was found that the amount of heat absorbed in the case with microbubbles generated was 1.86 times more than that in the case without microbubbles generated, as illustrated in FIG. 11. Thus, it is conceivable that containing microbubbles into cooling water contributes to cooling efficiency of a filling material of a cooling tower, a heat exchanger of a chiller, and a cooling device (e.g., a mold cooling hole, spot welding, a press die, and the like).

In addition, after 50 litters of hard water with total hardness 280 taken in the Nishikori water intake source in Nagahama city, Shiga prefecture, generating water with high total hardness, were poured into the experiment water tank while a microbubble generator (using a straight pipe of a standard number of A-17) was placed in the experiment water tank, the microbubble generator was operated continuously for seven days. As a result, it was found that calcium and magnesium, being scale components in water, aggregated into a colloid state and precipitated. In addition, the microbubble generator was continuously operated for seven days after 50 litters of industrial water from Kariya city, Aichi prefecture, which was soft water, were poured into the experiment water tank. As a result, it was found that calcium and magnesium, being scale components in water, aggregated into a colloid state and precipitated.

(4) Effect of Example

The microbubble generators 40A to 40C of the present example include respectively the straight pipes 41A to 41C that are made of porous ceramics, and each of which has one end connected to the compressor 42 and the other end blocked. The straight pipes 41A to 41C each have an average pore diameter of 1.5 μm or less. This causes air pumped to the internal space of each of the straight pipes 41A to 41C by the compressor 42 to pass through the pores of the corresponding one of the straight pipes 41A to 41C to become ultrafine high concentration microbubbles that are uniformly discharged into cooling water from the entire surface of the corresponding straight pipe. In addition, using the straight pipes 41A to 41C each made of porous ceramics enables a simple and inexpensive structure to be obtained.

While a ceramic filter in the shape of a lotus is generally used, it is not in actual use for water treatment because microbubbles generated therethrough varies in size. In contrast, the microbubble generators 40A to 40C of the present example uses the straight pipes 41A to 41C each made of alumina, respectively, so that they are excellent in ultrafine-bubble generation in which microbubbles have an accuracy of bubbles in size of 6 μm to 12 μm at a pore diameter of 1.2 μm that is a minimum limit of the alumina. In addition, high concentration microbubbles can be generated at a low air pressure of 0.15 MPa.

The present example uses the straight pipes 41A to 41C each having an outer diameter and an inner diameter that are different by 11.5 mm. This enables microbubbles to be more uniformly generated in cooling water.

The present example includes a filter 45 provided in a pipe connecting one end of each of the straight pipes 41A to 41C to the compressor 42. The filter 45 removes an oil component in air pumped by the compressor 42. This prevents the pores of each of the straight pipes 41A to 41C from being clogged by the oil component. In particular, the present example is configured such that the pipe downstream of the filter 45 is provided with the pressure adjusting regulator 46, the flow rate adjusting valve 47, and the chuck valve 48 for preventing a reverse flow of a liquid when pumping by the compressor 42 is stopped. This prevents deterioration in performance of high concentration microbubbles discharged from each of the straight pipes 41A to 41C.

The present example includes the housing 52 that is provided in its upper portion with the inflow port 51a of cooling water, and in its lower portion with the outflow port 51b of cooling water, and the straight pipe 41A is disposed in the housing 52 such that its axis c1 faces the horizontal direction. This enables a large amount of microbubbles to be contained in cooling water flowing in the housing 52.

The present example is configured such that the straight pipe 41A is disposed in the lower portion inside the housing 52. This enables a larger amount of microbubbles to be contained in the cooling water flowing in the housing 52.

The present example is configured such that the outflow port 51b is provided in the side wall of the housing 52, and such that the straight pipe 41A is provided in the housing 52 so as to have a vertical distance h of 100 mm or less between the axis c1 of the straight pipe 41A and the axis c2 of the outflow port 51b. This enables a larger amount of microbubbles to be contained in the cooling water flowing in the housing 52.

The present example is configured such that the outflow port 51b is provided in the side wall of the housing 52, and such that the straight pipe 41A is disposed in the housing 52 to allow the axis c1 of the straight pipe 41A to be substantially orthogonal to the axis c2 of the outflow port 51b in plan view. This enables a larger amount of microbubbles to be contained in the cooling water flowing in the housing 52.

The present example is configured such that the housing 52 is provided in its upper portion with the gas vent valve 58. As a result, gas accumulation in the housing 52 is eliminated, and cooling water smoothly flows in the housing 52.

The present example is configured such that the container 53 for containing the tourmaline granules 55 is disposed in the housing 52, and such that the straight pipe 41A is disposed below the container 53. This enables cooling water flowing in the housing 52 to be effectively improved in water quality.

The cooling water circulation system 1 of the present example includes the above microbubble generators 40A to 40C. As a result, ultrafine high concentration microbubbles can be evenly generated in cooling water. When the cooling water improved in water quality (or cooling water containing microbubbles) is circulated in a circulation path, contamination and clogging of the circulation path can be prevented and water quality of the cooling water can be maintained, thereby enabling further improvement in cooling efficiency. For example, when cooling water improved in water quality is circulated in the circulation path, a cluster of water (H2O aggregate) is decomposed to become permeable and smooth water. Then, OH radicals are generated to decompose and clean a rust lump, a scale deposit, an organic matter, and the like. In addition, the oxidation-reduction potential is negatively charged to cause the water to become minus ion water (weak alkali). Then, odors of molds, algae, and the like are removed from the circulating cooling water. The microbubbles have heat conduction about 1.8 times that of water, so that the cooling efficiency of sprinkle water cooling of a cooling tower, a heat exchanger, a cooling apparatus, and the like is improved.

The present invention is not limited to the example described above, and can be variously modified within the scope of the present invention depending on purpose and use. That is, while the example described above shows the microbubble generator 40A including the container 53 for containing the tourmaline granules 55 in the housing 52, the present invention is not limited thereto. For example, the microbubble generator 40A may include a container 79 for containing a water treatment agent 80 composed of an inorganic substance in the housing 52, as illustrated in FIG. 12. In addition, the microbubble generator may not include the containers 53 and 79 in the housing 52.

While the example described above shows the microbubble generators 40A to 40C that respectively include the plurality of straight pipes 41A to 41C, the present invention is not limited thereto. For example, the microbubble generator may include a single straight pipe 41 as illustrated in FIG. 7(c).

While the example described above shows the microbubble generator 40A for generating microbubbles in cooling water circulating through the chiller-machine-side circulation path 3, the present invention is not limited thereto. For example, the microbubble generator may generate microbubbles in cooling water circulating through the cooling-tower-side circulation path 3.

While the example described above shows the cooling water circulation system 1 including the three microbubble generators 40A to 40C, the present invention is not limited thereto. For example, the cooling water circulation system may include a combination of one or two of the three micro valve generators 40A to 40C. In addition, the cooling water circulation system may include another type of microbubble generator.

While the example described above shows the straight pipes 41A to 41C that face the horizontal direction in the housing 52 or the like, the present invention is not limited thereto. For example, the straight pipes may face a direction inclined from the horizontal direction, or the vertical direction. In addition, while the example described above shows the straight pipes 41A to 41C that are disposed in the lower portion in the housing 52 or the like, the present invention is not limited thereto. For example, the straight pipes may be disposed in the upper portion in the housing or the like. Further, while the example described above shows the straight pipe 41A with the axis c1 intersecting the axis c2 of the outflow port 51b in plan view, the present invention is not limited thereto. For example, the straight pipe may have the axis c1 that aligns with the axis c2 of the outflow port 51b in plan view.

While the example described above shows the gas vent valve 58 of a float type, the present invention is not limited thereto. For example, a gas vent valve of another type such as a pressure actuated type may be used.

While the example described above shows the microbubble generators 40A to 40C for prevention and removal of scales of cooling water, prevention and removal of corrosion (rust), and improvement in cooling efficiency, the microbubble generators may be also used for water purification of irrigation ponds, water heaters, septic tanks, coolers of air-conditioning outdoor units installed on rooftops of a building and the like, for example, because each of them has an effect of aggregating impurities in water into a colloid state as shown in the above Experimental Examples.

In addition, the microbubble generators 40A to 40C described above can be used for water purification, cleaning (for industrial use and household use), health care/rehabilitation (for hospital use and household use), chemical reaction promotion, cultivation (acceleration of fish and shellfish growth), hydroponic culture, humidification/cooling, spraying (chemical solution, fertilizer, water spraying, etc.), food processing, and the like, for example.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

### INDUSTRIAL APPLICABILITY

The present invention is widely used as a technique for generating microbubbles in a liquid used in industrial fields, medical fields, agricultural fields, environmental fields, food fields, and the like. Particularly, the present invention is suitably used as a technique for generating microbubbles in a liquid for piping under harsh conditions for use in factory facilities, prevention and removal of scales and corrosion (rust) of cooling equipment and the like, and improvement in cooling efficiency (power saving) of cooling equipment and the like.

### REFERENCE SIGNS LIST

1 cooling water circulation system
40A to 40C microbubble generator
41A to 41C straight pipe
42 compressor
45 filter
51a inflow port
51b outflow port
52 housing
58 gas vent valve
c1 axis of straight pipe
c2 axis of outflow port

1. A microbubble generator for generating microbubbles in a liquid, comprising:
a straight pipe made of porous ceramics having one end connected to a compressor and the other end blocked,
the straight pipe having an average pore diameter of 1.5 μm or less.

2. The microbubble generator according to claim 1, wherein
the straight pipe has an outer diameter and an inner diameter that are different by 8 mm to 17 mm.

3. The microbubble generator according to claim 1, wherein
a filter for removing an oil component in gas pumped by the compressor is provided in a pipe connecting one end of the straight pipe to the compressor.

4. The microbubble generator according to claim 1, further comprising:
a housing that is provided in its upper portion with an inflow port of a liquid and in its lower portion with an outflow port of a liquid,
wherein the straight pipe is disposed in the housing such that its axis faces a horizontal direction.

5. The microbubble generator according to claim 4, wherein
the straight pipe is in a lower portion in the housing.

6. The microbubble generator according to claim 4, wherein
the outflow port is provided in a side wall of the housing, and
the straight pipe is disposed in the housing so as to have a vertical distance of 200 mm or less between the axis of the straight pipe and an axis of the outflow port.

7. The microbubble generator according to claim 4, wherein
the outflow port is provided in the side wall of the housing, and
the straight pipe is disposed in the housing such that the axis of the straight pipe and the axis of the outflow port intersect with each other in plan view.

8. The microbubble generator according to claim 4, wherein
the inflow port is provided in the side wall of the housing, and
the outflow port is provided in the side wall of the housing on a side facing the inflow port.

9. The microbubble generator according to claim 4, wherein
the housing is provided in its upper portion with a gas vent valve for venting gas stored in an upper portion of the housing.

10. A cooling water circulation system for circulating cooling water in a circulation path, comprising:
the microbubble generator according to claim 1.
